(19) United States
(12) Patent Application Publication
(10) Pub. No.: US 2001/0027395 A1
(43) Pub. Date: Oct. 4, 2001

(54) Read-aloud device

(75) Inventors: Masaaki Sakai, Mooka-shi (JP); Tamaya Ubukata, Mooka-shi (JP)

Correspondence Address: CHAPMAN AND CUTLER, 111 WEST MONROE STREET, CHICAGO, IL, 60603, US

(73) Assignee: TSUKUBA SEIKO LTD., Mooka-shi (JP)

(21) Appl. No.: 09/821,142

(22) Filed: Mar. 29, 2001

(30) Foreign Application Priority Data
Mar. 31, 2000 (JP) 2000-98167
Mar. 16, 2001 (JP) 2001-75672

(51) Int. Cl. G10L 13/00

(52) U.S. Cl. 704/258

(57) ABSTRACT

A read-aloud device including a reading device (50) for reading a sentence information recorded on a recording medium (MY) and a voice information of a human voice that read-aloud this sentence, a display screen (31) for displaying the sentence of the sentence information read by the reading device (50), a voice reproduction circuit (55) for reproducing the voice information read by the reading device and providing a read-aloud sound corresponding to the sentence displayed on said display screen (31), a speaker (SP), and a read-aloud speed control means for controlling a read-aloud speed of the read-aloud sound outputted by the speaker (SP).

### BACKGROUND OF THE INVENTION

1. Field of the Invention

This invention relates to a read-aloud device which displays a sentence on a display screen and outputs a read-aloud sound of the sentence displayed on the display Been.

2. Description of the Prior Art

Conventionally, this kind of read-aloud device is disclosed in Japanese Patent Laid-Open No. Hei 6-202686.

As shown in FIG. 10, such read-aloud device comprises a first input device (1) or reading a text data recorded on a floppy disk which is not shown, a second input device (2), an operation processing device (3), and a memory device (4).

The operation processing device (3) has a sentence analysis part (5), a voice synthesis regulation part (6), and a voice synthesis part (7).

The document analysis part (5) determines a letter type of the text data read by the first input device (1), and at the same time, generates a phoneme/rhythm control signal corresponding to the determined letter type based on a dictionary data recorded in the memory device (4).

The voice synthesis regulation part (6) reads a voice element data from a voice unit memory part (4a), based on the generated phoneme/rhythm control signal. The read voice element data is synthesized to a tine series by the voice synthesis part (7) and outputs as a synthetic speech signal, then this synthetic speech signal is inputted into an output device (8), i.e. a speaker, and the synthetic speech is outputted from the output device (8).

However, since such read-aloud device outputs a synthetic speech from the output device (8), there are problems that a read-aloud is mechanical and hard to understand. Further, it is impossible to change a read-aloud speed, as user desires. Further, it is difficult to know which letter is being read-aloud in the sentence.

### SUMMARY OF THE INVENTION

The first object of the invention is to provide a read-aloud device which can output a read-aloud sound in a human voice for a sentence displayed on a display screen, and at the same time, can change a speed of the read-aloud.

The second object of the invention is to provide a read-aloud device by which user can know which letter in the sentence is being read-aloud at a glance.

In order to achieve the first object, there is provided a read-aloud device comprising:

a reading means for reading a sentence information recorded on a recording medium and a voice information of a human voice which read-aloud this sentence

a display means for displaying the sentence of the sentence information read by said reading means;

a voice output means for reproducing the voice information read by said reading means corresponding to the sentence displayed on said display means, and outputting a read-aloud sound of a human voice; and

a read-aloud speed changing means for changing a read-aloud speed of the read-aloud sound outputted by said voice output means.

In order to achieve the second object, there is provided a read-aloud device comprising:

a reading means for reading sentence information recorded on a recording medium and voice information of a human voice which read-aloud this sentence;

a display means for displaying the sentence of the sentence information read by said reading means;

a voice output means for reproducing the voice information read by said reading means corresponding to the sentence displayed on said display means, and outputting a read-aloud sound of a human voice; and

a voice recognition means for recognizing the voice of read-aloud sound outputted by said voice output means;

wherein said display means displays a mark in the letter position of the displayed sentence corresponding to the voice recognized by said voice recognition means, and at the same time, moves the mark in accordance with the read-aloud sound.

### BRIEF DESCRIPTION OF THE DRAWING

FIG. 1 illustrates a read-aloud device according to this invention;

FIG. 2 is a block diagram showing a control system of the read-aloud device shown in FIG. 1;

FIG. 3 illustrates information recorded on a recording medium;

FIG. 4 is a flowchart showing an operation of the read-aloud device;

FIG. 5 is a flowchart showing an operation of the read-aloud device;

FIG. 6 illustrates a display screen of the read-aloud device:

FIG. 7 illustrates a status in which a sentence of original text is displayed on the display seen;

FIG. 8 illustrates a status in which commentary information is displayed on the display seen;

FIG. 9 illustrates a status in which sentence in page 2 of the original text and image are displayed on the display screen; and

FIG. 10 is a block diagram showing a configuration of the prior read-aloud device.

### DETAILED DESCRIPTION OF THE EMBODIMENT

Hereinafter, preferred embodiments of the read-aloud device according to this invention will be described with reference to the drawings.

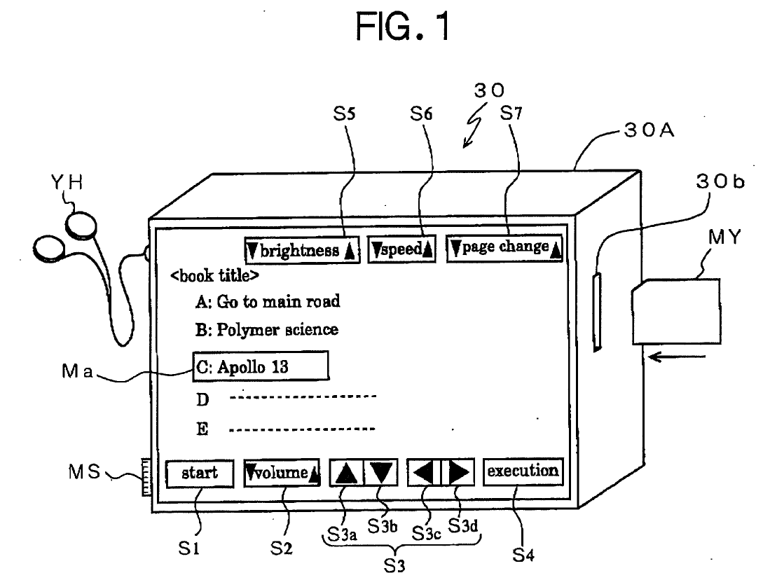

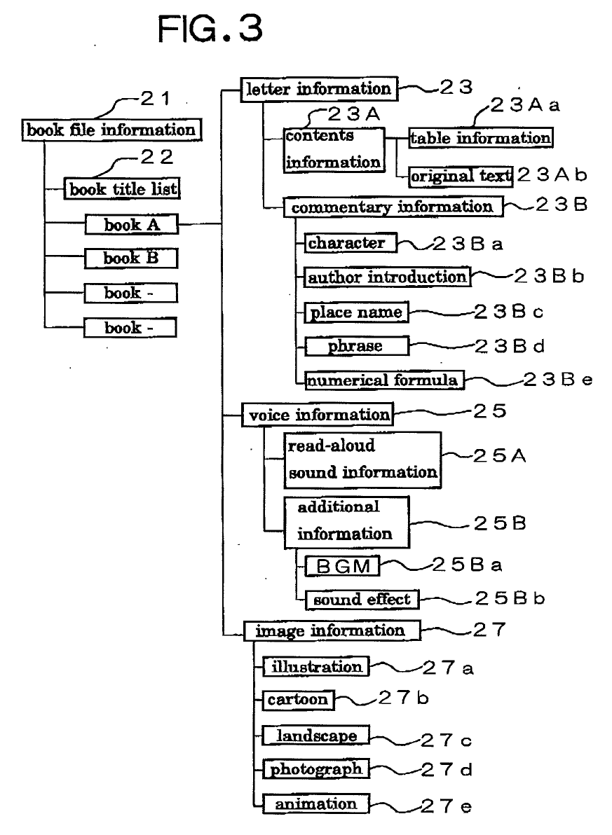

A read-aloud device (30) shown in FIG. 1 has a case-shaped devise body (30A), a display screen (31) is equipped at the front surface of the device body (30A). At the left surface of device body (30A), there are equipped a connect terminal (not shown) which can connect an earphone (YH) so as to engage and disengage freely and a main switch (MS). Also, at the right surface of the device body (30A), there is formed a loading opening for loading a storage medium (MY) recording a book file information (21) (refer to FIG. 3). The storage medium (MY) is, for example a floppy disk, but it may be a CD, MD, CD-ROM, IC memory, etc.

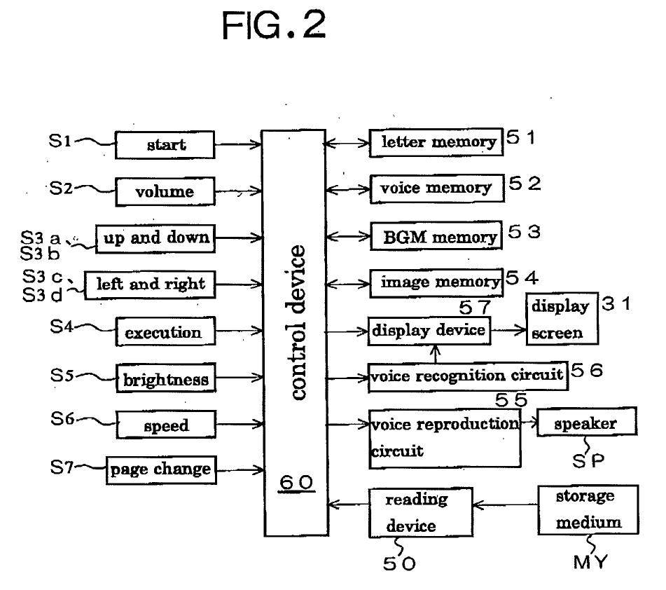

Also, a speaker outputting a read-aloud sound, etc. (refer to FIG. 2), is built-in within the device body (30A), and thereby an output from the speaker is stopped upon connecting the earphone (YH), and the read-aloud sound is outputted only through the earphone (YH).

At the lower side of the display screen (31), there are equipped a start switch (S1), a volume switch (S2), a cursor moving switch (S3) and an execution switch (S4) consisting of a transparent touch panel. Also, at the upper side of the display screen (31), there are equipped a brightness switch (S5), a speed switch (S6) and a page change switch (S7) consisting of a transparent touch panel.

The start switch (S1) is configured to execute a read-aloud start and a read-aloud stop alternately whenever it is touched. The volume switch (S2) is configured to decrease a volume if the left side is touched and to increase the volume if the right side is touched.

The cursor moving witch (S3) is configure to move a cursor (K) (refer to FIG. 7) displayed on the display screen (31) into up, down, left and right direction so that the cursor (K) is moved to up if a switch (S3a) is touched, the cursor (K) is moved to down if a switch (S3b) is touched, the cursor (K) is moved to left if a switch (S3c) is touched and the cursor (K) is moved to right if a switch (S3d) is touched.

The brightness switch (S5) is configured to control the brightness of the display screen (31) so that the display screen becomes darker if a left side is touched and lighter if a right side is touched. The speed switch position (S6) is configured to change a read-aloud speed so that speed becomes slow if a left side is touched and the speed becomes fast if a right side is touched. The page change switch (S7) is configured so that it returns a page displayed on the display screen (31) into a previous page if a left side is touched and it progresses into a next page if a right side is touched.

FIG. 2 is a block diagram showing a control system of the read-aloud device (30). In FIG. 2, reference numeral 50 is a reading device for reading a hook file information recorded on a recording medium (MY), 51 is a letter memory for memorizing a letter data, 52 is a voice memory for memorizing a voice data, 53 is a BGM memory for memorizing back ground music information or sound effect information, and 54 is an image memory for memorizing an image data. 55 is a voice reproduction circuit for reproducing and outputting a voice signal, etc., based on a voice data outputted from a control device (60), 56 is a voice recognition circuit for recognizing a voice of read-aloud sound outputted from a speaker (SP) based on the voice information signals from the control device (60), and 57 is a display device for displaying image, letter and cursor (K) on the display screen (31).

The display device (57) has a CPU, etc., so that it functions to correspond a voice recognized by the voice recognizing circuit (55) to letters of sentence displayed on the display screen, and simultaneously to move the cursor (K) to a position of letter corresponding to the voice.

The control device (60) is configured with CPU, etc, so that it controls the display device (57) or the reading device (50), etc., based on operations of each switch (S1-S7). Further the control device (60) also serves as a read-aloud speed changing means for changing the read-aloud speed according to a touch of a speed switch (S6).

FIG. 3 shows contents of book file information (21) recorded on the storage medium (MY). The book file information (21) has book title list information (22) inscribing the titles of all recorded books and book information of each book (A, B . . . ).

The book information of each book (A, B . . . ) has letter information (23), voice information (25), and image information (27). The letter information (23) has contents information (23A) and commentary information (23B), the contents information (23A) has table information of the book (23Aa), and sentence information (23Ab) which is a sentence of the book. Voice information (25) and image information (27) are recorded corresponding to a page of the sentence displayed on the display screen (31).

The commentary information (23B) has character information (23Ba) for indicating origin or experiences of character who appears on the original text, author introduction information (23Bb) for introducing an author, place name information (23Bc) with respect to a place appearing in sentence, phrase information (23Bd) for explaining a phrase of sentence, and numeric formula information (23Be) for explaining a numerical formula appearing in sentence.

The voice information (25) has read-aloud sound information (25A) of a human voice which read-aloud a sentence of book and additional information (25B). The additional information (25B) has back ground music information (25Ba) and each kind of sound effect (25Bb) such as sound of the wave or a car.

The image information (27) has illustration information (27a), cartoon information (27b), landscape information (27c), photograph information (27d) and animation information (27e) of illustration, cartoon, landscape, photograph and animation displayed on the display green (31).

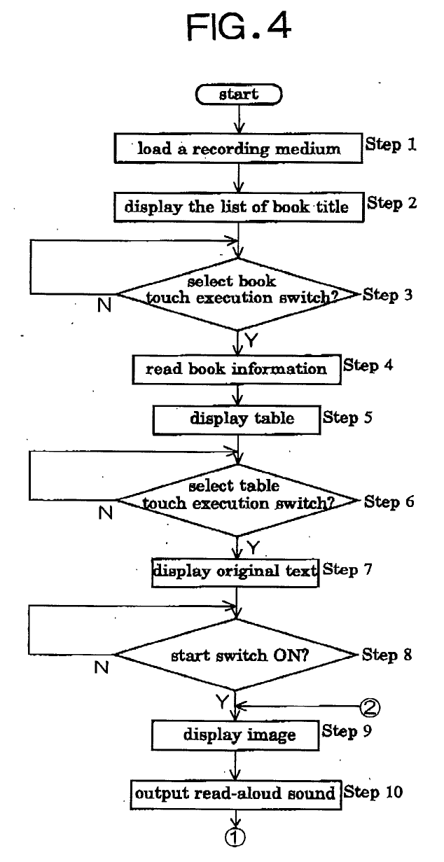

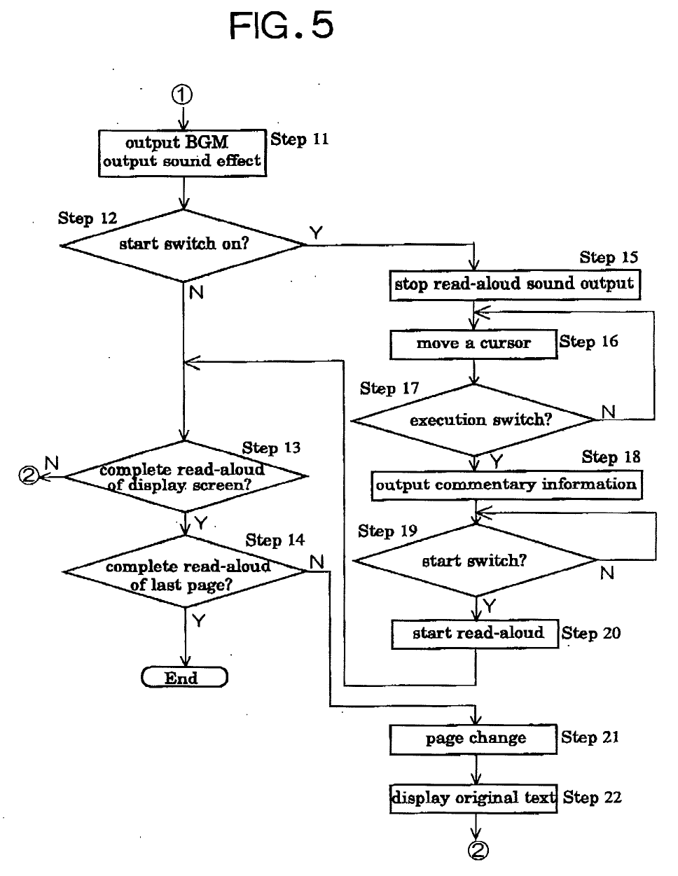

Next, an operation of the read-aloud device configured as described above will be explained based on the flowcharts shown in FIG. 4 and FIG. 5.

At first, if the recording medium (MY) is loaded the device body (30A) with a main switch (MS) ON (Step 1), the reading device (50) reads the book title list information recorded on the recording medium (MY), and then the titles of all books recorded on the recording medium (MY) are displayed on the display screen (31), as shown in FIG. 1 (Step 2). Also, a mark Via) with rectangular frame is displayed on the display screen (31), and the mark (Ma) indicates the selection of the book whose title is surrounded by it. In FIG. 1, the book (C) is selected. The change of the selection is executed by moving the mark (Ma) up and down with touch of the switches (S3a, S3b).

In Step 3, it is determined whether the execution switch (S4) is touched with the book selection or not, and if the result is NO, the process returns back to Step 3 and becomes standing-by state in Step 3 until the execution switch (S4) is touched. If the execution switch (S4) is touched, it is determined as YES in Step 3 and the process goes to Step 4.

In Step 4, the book information of the book (C) selected by the mark (Ma) is read. In other words, the letter information (23), read-aloud sound information (25A), the additional information (25B), and the image information (27) are read, and then the letter information (23) is memorized in the letter memory (51), the read-aloud sound imformation (25A) is memorized in the voice memory (52), the additional information (25B) is memorized in the BGM memory (53), and the image information (27) is memorized in the image memory (54).

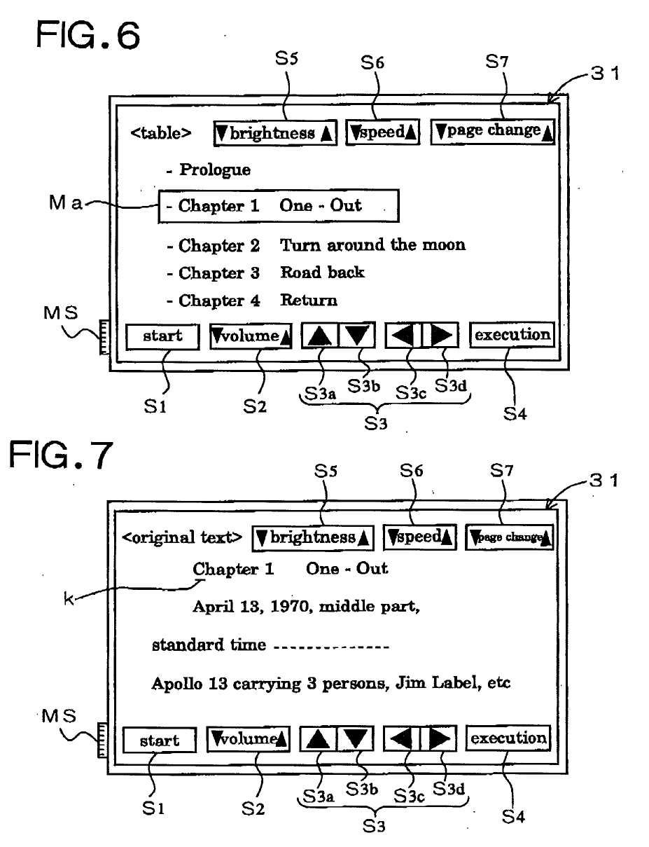

In Step 5, the table information (23Aa) memorized in the letter memory (51) is read, the table is displayed on the display screen (31) as shown in FIG. 6. In Step 6, dead table is selected by touching the switches (S3a, S3b) as in Step 3, and it is determined whether the execution switch (S4) has been touched or not. If the result is NO, the process returns back to Step 6 and becomes a standing-by state in Step 6 until the execution switch (S4) is touched.

If the execution switch (S4) is touched, it is determined as YES in Step 6 and the process goes to Step 7, In Step 7, there is displayed on the display screen (31) the sentence within the original text of the first page in the table selected as shown in FIG. 7. Also, on the display screen (31), the cursor is displayed at the position of the first letter starting the read-aloud.

And, in Step 8, it is determined whether the start switch (S1) has been touched or not, if the result is NO, the process returns back to Step 8 and becomes a standing-by state in Step 8 until the start switch (S1) is touched. If the start switch (S1) is touched, it is determined as YES and the process goes to Step 9.

In Step 9, if there is image information corresponding to the sentence within the original text displayed on the display screen (31) shown in FIG. 7, it is read from the image memory (53) and the image is displayed on the display screen (31). In Step 10, the read-aloud sound information (26A) of the sentence displayed on the display screen (31) shown in FIG. 7 is read from the voice memory (52), and the read-aloud information signal of this read-aloud sound information (25A) is outputted from the voice reproduction circuit (55). The voice reproduction circuit (55) reproduces and outputs the read-aloud sound signal from the read-aloud sound information signal, and the read-aloud sound of a human voice is outputted from the speaker (SP).

Due to the read-aloud sound of a human voice, the read-aloud is natural so that it becomes very easy to listen. Also, the image corresponding the read-aloud is displayed on the display screen (31), it may become easy to understand the image of the read-aloud contents.

In Step 11, if there is back ground music information (25Ba) or sound effect information (25Bb) corresponding the sentence on the page displayed on the display screen (31) shown in FIG. 7, it is read from the BGM memory (53), the back ground music information signal or the sound effect signal is outputted into the voice reproduction circuit (55) and the back ground music or sound effect is outputted with the read-aloud from the speaker (SP). Due to the back ground music or sound effect output, the read-aloud becomes fulfill with the reality.

Meanwhile, the read-aloud sound information signal of the read-aloud sound information (25A) read from the voice memory (52) is outputted into the voice reproduction circuit (56). The voice recognition circuit (56) recognizes the voice of the read-aloud sound outputted from the speaker (SP) based on the read-aloud sound information signal, and outputs this recognized voice recognition signal. The display device (57) starts to correspond the voice recognition signal recognized by the voice recognition circuit (56) with the letter within the sentence displayed on the display screen (31), and simultaneously starts to move the cursor (K) into the position of the letter corresponding to the voice recognition signal.

That is, the cursor (K) starts to move corresponding to the voice of read-aloud sound with the progress of read-aloud, thereby it becomes possible to know at a glance which letter is being read-aloud by the cursor (K).

However, since the cursor (K) is displayed in the position of letter stag the read-aloud, it is possible to move the cursor (K) accurately into the position where the letter is currently read-aloud by moving the cursor (K) with starting the read-aloud.

In Step 12, it is determined whether the start switch (S1) is touched or not, and if the result is NO, the process goes to Step 13. In Step 13, it is determined whether the read-aloud of the sentence displayed on the display screen (31) is completed or not, and, if the result is NO, the process returns back to Step 9 and the processing operation from Step 9 to Step 13 is repeated until the read-aloud of the sentence displayed on the display screen (31) is ended.

In case that it is wanted to know the commentary of the character or terminology written in the sentence displayed on the display screen (31) shown in FIG. 7, the start switch (S1) is touched. Then, it is determined as YES in Step 12, the process goes to Step 15.

In Step 15, it is stopped to output the read-aloud sound. And, the terminology is designated by touching a cursor moving switch (S3) to move the cursor (K) into the position of the terminology wanted to know the commentary (Step 16). In Step 17, it is determined whether the execution switch (S4) is touched or not, if the result is NO, the process returns bark to Step 16. Processing operation of the Stop 16 and 17 is executed repeatedly until the execution switch (S4) is touched.

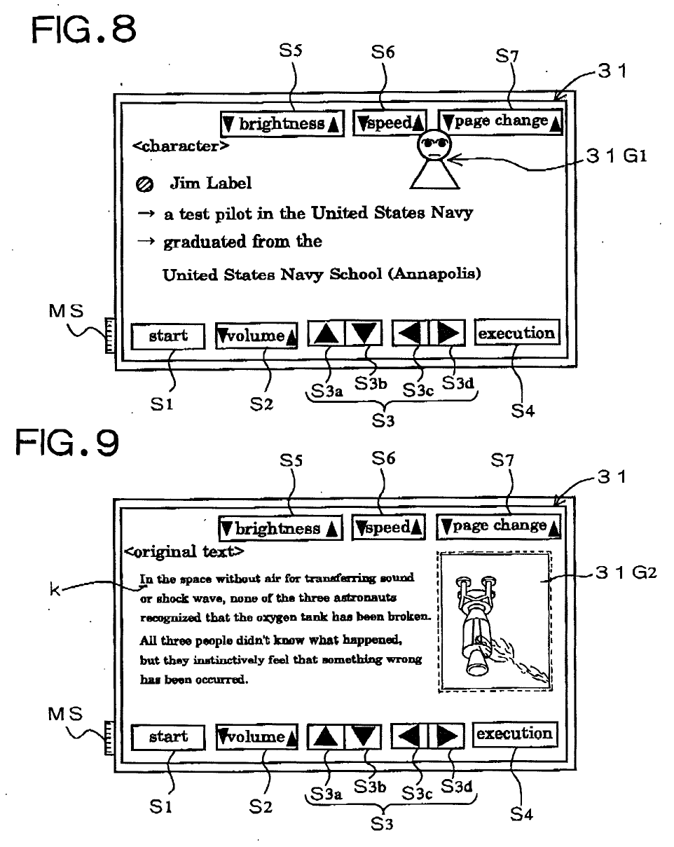

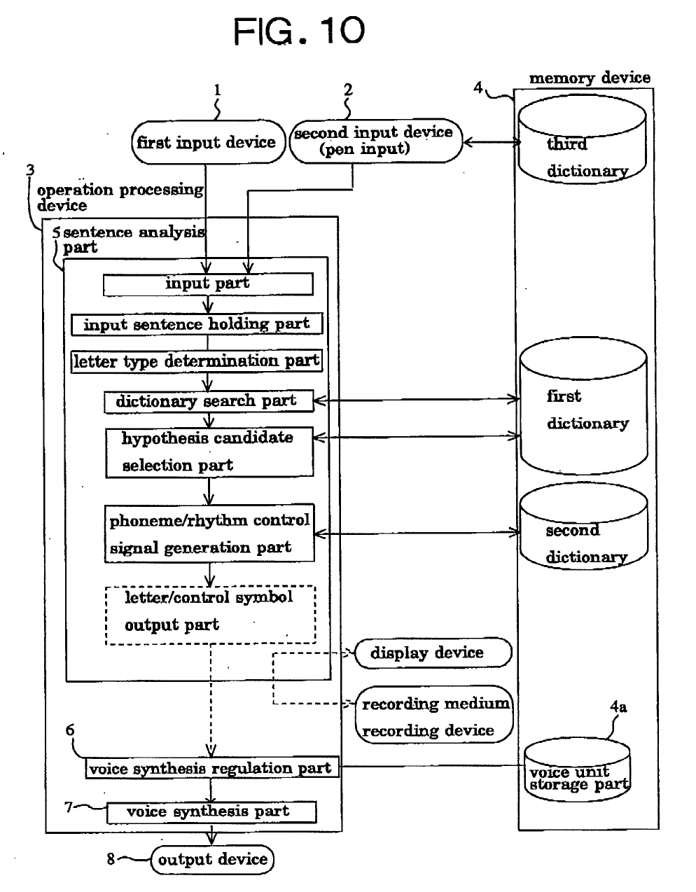

If the execution switch (S4) is touched, it is determined as YES in Step 17 and the process goes to Step 18. In Step 18, the commentary information of the terminology designated by the cursor (K) is read from the letter memory (51), and displayed on the display screen (31) as shown in FIG. 8. FIG. 8 is the case in which character, Jim Label (refer to FIG. 7) is designated by the cursor (K) and the experience of the character is displayed. Also, if there is image information (27) about the character, Jim Label, it will be read from the image memory (54) and the image (31G1) is displayed on the display screen (31).

In Step 19, it is determined whether the start switch (S1) is touched or not, if the result is NO, the process returns back to Step 19. That is, the process becomes a standing-by state in Step 19 until the start switch (S1) is touched.

If the start switch (S1) is touched, it is determined as YES in Step 19 and the process goes to Step 20. In Step 20, the display screen (31) shown in FIG. 7 is displayed again, simultaneously the read-aloud is started again from the letter which has been stopped the read-aloud, and then the process returns back to Step 13.

In this way, it is able to know the contents in detail by displaying the experience of the character, etc. Also, it becomes to be easy to understand the contents by displaying the commentary such as terminology.

If the read-aloud of the sentence displayed on the display sheen (31) shown in FIG. 7 is completed, it is determined as YES in Step 13 and the process goes to Step 14. In Step 14, it is determined whether the read-aloud of the last page is completed or not, if the result is NO, the process ends or if the result is YES, it goes to Step 21.

In Step 21, the letter information of the sentence within the next page (page 2) is read from the letter memory (51), and the letter of the sentence in the page 2 is displayed on the display screen (31) as shown in FIG. 9 to proceed to Step 9. In Step 9, if there is image information corresponding to the sentence on the page 2 displayed on the display screen (31), it is read from the image memory (53) and the image of the image information (31G2) is displayed on the display screen (31). And, in Step 10, it is started to read-aloud the sentence on the page 2 displayed on the display screen (31), and the cursor (K) starts to move with this read-aloud in the same manner as described above. And, the processing operation in Step 11 to Step 14, Step 21 and Step 22 starts to be executed as described above.

That is, the processing operation in Step 9 to Step 14, Step 21 and Step 22 is executed repeatedly until the read-aloud of the last page is completed, it is determined as YES in Step 14 if the read-aloud of the last page is completed and the process ends.

However, in case that it is wanted to change the read-aloud speed before beginning or during the read-aloud, right or left side of the speed switch (S6) is touched. Due to this touch, the speed of read-aloud becomes fast or slow. Since it is possible to change the read-aloud speed in this manner, it is also possible to listen the read-aloud at easy to listen speed.

Such change of the read-aloud speed is performed by changing the breath time during the read-aloud, or by changing the time until the movement for pronunciation of next letter after completing the pronunciation of 1 letter. Thus, although the read-aloud speed is changed, there is no case in which the read-aloud sound becomes high or low.

In the above embodiment, although the cursor (K) is moved according to the read-aloud, it is possible to invert-display the letter which is being read-aloud, and then move the invert-display according to the read-aloud. Also, it is possible to display a mark to the letter, and then move the mark.

Further, it is possible to take a mark to the terminology having commentary information, and then notify that there is commentary information.

What is claimed is:

1. A read-aloud device comprising:
a reading means for reading a sentence information of a sentence recorded on a recording medium and a voice information of a human voice which reads-aloud the sentence;
a display means for displaying the sentence of the sentence information read by said reading means;
a voice output means for reproducing the voice information read by said reading means corresponding to the sentence displayed on said display means, and outputting a read-aloud sound of a human voice; and
a read-aloud speed changing means for changing a read-aloud speed of the voice on an output of said voice output means.

2. A read-aloud device comprising:
a reading means for reading a sentence information of a sentence recorded on a recording medium and a voice information of a human voice which reads-aloud this sentence;
a display means for displaying the sentence of the sentence information read by said reading means;
a voice output means for reproducing the voice information read by said reading means corresponding to the sentence displayed on said display means, and outputting a read-aloud sound of a human voice; and
a voice recognition means for recognizing the voice of the read-aloud sound outputted by said voice output means;
wherein said display means displays a mark in a letter position in the displayed sentence corresponding to reading by the voice recognized by said voice recognition means, said mark moving in accordance with the read-aloud sound.

3. A read-aloud device according to claim 2, wherein said mark is a cursor.

4. A read-aloud device according to claim 1, wherein an image information for a plurality of images is recorded on said recording medium, then said reading means reads the plurality of images, finding an image corresponding to a sentence displayed on said display means and displaying said image on said display means along with the sentence.

5. A read-aloud device according to claim 1, wherein a commentary information corresponding to a predetermined phrase in said sentence is recorded on said recording medium, said reading means reading the commentary information, and said display means displays said commentary information along with the predetermined phrase.

6. A read-aloud device according to claim 1, wherein a background music data corresponding to said sentence is recorded on said recording medium, said reading means reading the background music data, and said voice output means reproduces said background music data and plays the background music when said display means displays said sentence.

7. A read-aloud device according to claim 1, wherein a sound effect data corresponding to said sentence is recorded on the recording medium, said reading means reading said recorded sound effect data, and said voice output means reproduces said sound effect data and provides said sound effect when said display means displays said sentence.

8. A read-aloud device according to claim 2, wherein an image information for a plurality of images is recorded on said recording medium, then said reading means reads the plurality of images, finding an image corresponding to a sentence displayed on said display means and displaying said image on said display means along with the sentence.

9. A read-aloud device according to claim 2, wherein a commentary information corresponding to a predetermined phrase in said sentence is recorded on said recording medium, said reading means reading the commentary information, and said display means displays said commentary information along with the predetermined phrase.

10. A read-aloud device according to claim 2, wherein a background music data corresponding to said sentence is recorded on said recording medium, said reading means reading the background music data, and said voice output means reproduces said background music data and plays the background music when said display means displays said sentence.

11. A read-aloud device according to claim 2, wherein a sound effect data corresponding to said sentence is recorded on the recording medium, said reading means reading said recorded sound effect data, and said voice output means reproduces said sound effect data and provides said sound effect when said display means displays said sentence.
